(19) United States
(12) Patent Application Publication
(10) Pub. No.: US 2024/0204633 A1
(43) Pub. Date: Jun. 20, 2024

(54) Method for Producing a Rotor by Means of a Flexible Coil Carrier, Electric Machine, and Motor Vehicle

(71) Applicant: Bayerische Motoren Werke Aktiengesellschaft, Muenchen (DE)

(72) Inventor: Torsten FRANKE, Muenchen (DE)

(21) Appl. No.: 18/287,494

(22) PCT Filed: May 23, 2022
(86) PCT No.: PCT/EP2022/063888

§ 371 Date: Oct. 19, 2023

(30) Foreign Application Priority Data
Jun. 22, 2021 (DE) 10 2021 116 054.5

(51) Int. Cl. H02K 15/02; H02K 3/34; H02K 15/06

(52) U.S. Cl. CPC H02K 15/026; H02K 3/345; H02K 15/062

(57) ABSTRACT

A method for producing the periphery of a rotor for a current-excited electric machine includes providing a rotor yoke, rotor poles formed separately from and mechanically connectable to the rotor yoke, and a coil carrier having a plurality of coil bodies and flexible connecting sections located between the coil bodies and by which the position of the coil bodies relative to one another is changeable. The coil carrier is brought into a production position by the flexible connecting sections and is equipped with an energizable winding by winding sections wound around the coil bodies. The rotor poles and the coil bodies are joined together to form pole coils. The coil carrier is transferred from the production position to an installation position by the flexible connecting sections, and the rotor poles, which are connected to the coil bodies of the coil carrier, are mechanically connected to the rotor yoke.

### BACKGROUND AND SUMMARY

The invention relates to a method for producing at least part of the circumference of a rotor for a current-excited electric machine, in which a rotor yoke and rotor poles which are formed separately from the rotor yoke and are mechanically connectable to the rotor yoke are provided. The invention also relates to a current-excited electric machine, and to a motor vehicle.

Interest is focused here on current-excited electric machines for electrically drivable motor vehicles, for example electric or hybrid vehicles. The electric machines have a positionally fixed stator with energizable stator windings, and a rotor which is mounted rotatably with respect to the stator and has a rotor winding. The rotor has a rotor core which carries the rotor windings. The rotor core conventionally consists of an annular rotor yoke and a plurality of rotor poles which are arranged on the rotor yoke along a rotor circumference. The rotor poles conventionally consist of in each case one rotor tooth or rotor shaft protruding radially from the rotor yoke and a pole shoe which is in the shape of a circular segment and protrudes tangentially on the rotor tooth. The pole shoes form a substantially cylindrical rotor circumference of the rotor core. Pole gaps into which winding portions of the rotor winding are introduced to form pole coils are formed between the rotor teeth.

In order to introduce the pole coils into the pole gaps or pole slots, the pole shoes of two adjacent rotor poles are arranged spaced apart from one another such that they open up an access opening on the rotor circumference into the pole gaps. In order to form the pole coils, a winding conductor in the form of a wire is introduced via the access openings into the pole gaps using a tool. The winding wire is then wound around the rotor teeth, with the intention being to achieve a high filling factor. The tangentially protruding pole shoes mean that the access openings into the pole gaps are smaller than a pole gap diameter, and therefore the pole gaps can be filled with the winding wire only with great difficulty. As a result, a non-optimum winding quality and therefore a non-optimum filling factor frequently arise.

To this end, DE 10 2018 213 567 A1 discloses a rotor for a separately excited internal-rotor synchronous machine, in which the rotor poles are formed in multiple parts. The rotor poles each have a rotor tooth and two separate pole shoe elements, wherein the rotor teeth are formed integrally with the rotor yoke, and the pole shoe elements are mechanically connectable to the rotor teeth after the rotor coils have been arranged on the rotor teeth. Two pole shoe elements are arranged on two sides of the rotor tooth lying opposite one another in the tangential direction, and are connected to the rotor tooth in a form-fitting manner, for example via a dovetail-like connection. Such a rotor is highly complicated to produce.

It is an object of the present invention to provide an easily manufacturable rotor for a current-excited electric machine.

This object is achieved according to the invention by a method for producing a rotor, a current-excited electric machine, and a motor vehicle having the features according to the respective independent patent claims. Advantageous embodiments of the invention are the subject matter of the dependent patent claims, the description and the figures.

A method according to the invention serves for producing at least part of the circumference of a rotor for a current-excited electric machine. A rotor yoke and rotor poles which are formed separately from the rotor yoke and are mechanically connectable to the rotor yoke are provided here. In addition, a coil carrier is provided which has a plurality of coil bodies and flexible connecting portions which are arranged between the coil bodies and via which a relative position of the coil bodies with respect to one another can be changed. The coil carrier is brought into a manufacturing position via the flexible connecting portions and equipped with an energizable winding by winding winding portions around the coil bodies. The rotor poles and the coil body are then joined together such that the respective winding portions are wound around the rotor poles to form pole coils. The coil carrier is transferred from the manufacturing position into an installation position via the flexible connecting portions, and the rotor poles, which are connected to the coil bodies of the coil carrier, are mechanically connected to the rotor yoke.

The invention also includes a rotor produced by the method according to the invention and a current-excited electric machine having a stator and a rotor according to the invention which is mounted rotatably with respect to the stator. The current-excited or separately excited electric machine is in particular an internal-rotor machine, in which the rotor is mounted within the hollow-cylindrical stator so as to be rotatable about an axis of rotation. The rotor has a rotor core and components which generate a magnetic field and have a (rotor) winding to generate a rotor magnetic field. The rotor core can be mechanically connected to a driveshaft of the motor vehicle in order to transmit torque. The rotor core can be formed from solid material, for example from iron, or in the form of a laminated core consisting of axially stacked sheet metal laminations. The rotor core is formed in multiple parts and has the annular rotor yoke and the rotor poles. The rotor yoke and the rotor poles are mechanically connected during the production of the rotor.

The rotor poles each have a rotor tooth or rotor shaft and also a pole shoe. The rotor poles serve for holding the pole coils of the rotor winding, with the pole shoes being configured, inter alia, to prevent the pole shoes from becoming detached from the respective rotor pole due to the radially outwardly acting centrifugal force during the rotation of the rotor. The pole shoes have, for example, a cross section in the shape of a circular segment, and protrude laterally in regions on the rotor tooth such that the rotor poles are substantially mushroom-shaped.

The pole coils are not wound around the respective rotor tooth, but rather are first of all arranged on the single-piece, flexible coil carrier. The coil carrier has a number of coil bodies corresponding to the number of rotor poles, the coil bodies being connected mechanically to one another via the flexible, reversibly bendable connecting portions. The coil carrier can be, for example, a plastics injection molded part. To equip the coil body with the winding, the coil carrier is brought into the manufacturing position or equipping position. In the manufacturing position, the coil bodies which are connected via the flexible connecting portions in particular form a coil body chain. Expressed in other words, the coil bodies are arranged linearly in a row next to one another. In this manufacturing position, portions of the winding wire of the rotor winding can be wound particularly simply around the coil bodies. Each winding portion wound around a coil body forms a pole coil. The winding wire is wound in particular without interruption around all of the coil bodies to form the pole coils.

The rotor poles are now arranged on the coil carrier. The coil carriers here are hollow bodies into which the rotor poles can be pushed. The hollow bodies have in particular a shape corresponding to the rotor teeth, for example a cuboidal shape, and therefore the rotor teeth can be arranged in the hollow bodies. The coil carrier which is equipped with the rotor coils is then brought into the installation position or installation geometry. Alternatively thereto, the coil carrier can also firstly be brought into the installation position and then equipped with the rotor poles. In the installation position, the coil bodies in particular form a coil body ring. The coil carrier is therefore annular and can thus be pushed together axially with the annular rotor yoke such that the coil body radially surrounds the rotor yoke.

During the pushing-together operation, the rotor poles are mechanically connected to the rotor yoke. A form-fitting tongue and groove connection is preferably produced here between the rotor yoke and the rotor poles. For example, a dovetail-like connection can be produced as the tongue and groove connection. For this purpose, the rotor poles can have, for example, a respective dovetail-shaped or circular tongue which is pushed axially into a dovetail-shaped or circular groove in the rotor yoke.

Such a production method in which a flexible coil carrier is provided facilitates the manufacturing of the rotor in respect of being equipped with the rotor winding. In addition, a high filling factor can be achieved.

Particularly preferably, before the coil carrier is connected to the rotor poles, a flexible insulation covering is arranged on the coil carrier equipped with the winding, the insulation covering being transferred together with the coil carrier from the manufacturing position into the installation position. The insulation covering is therefore likewise flexible. For this purpose, the insulation covering is configured with first, flexible pole insulation regions which are arranged in pole gaps between two pole coils, and is configured with second pole insulation regions which each have a passage opening for the rotor pole and, when the rotor yoke and coil carrier are joined together, are arranged between the rotor yoke and the pole coils. The first pole insulation regions can be configured here as, in particular triangular and/or trapezoidal, folds. Provision can be made here that the insulation covering is produced by the passage openings being punched out in an electrically insulating material, and the electrically insulating material being unfolded to form the first pole insulation regions. Alternatively thereto, the insulation covering can be injection molded to form the first pole insulation regions and the passage openings.

A motor vehicle according to the invention comprises a current-excited electric machine according to the invention. The motor vehicle is designed as an electric or hybrid vehicle and has the electric machine as the drive machine.

The embodiments presented with respect to the method according to the invention and the advantages thereof apply correspondingly to the current-excited electric machine according to the invention and to the motor vehicle according to the invention.

Further features of the invention emerge from the claims, the figures and the description of the figures. The features and combinations of features mentioned above in the description and the features and combinations of features mentioned below in the description of the figures and/or shown solely in the figures can be used not only in the respectively stated combination, but also in different combinations or by themselves.

The invention will now be explained in more detail using a preferred exemplary embodiment and with reference to the drawings, in which:

### BRIEF DESCRIPTION OF THE DRAWINGS

FIG. 1 shows a schematic illustration of an embodiment of a rotor;

FIG. 2 shows a schematic illustration of the rotor during production of the rotor;

FIG. 3 shows a schematic illustration of an insulation covering of the rotor;

FIG. 4 shows a schematic diagram of the winding;

FIG. 5 shows a schematic illustration of a coil carrier of the rotor in a manufacturing position; and

FIG. 6 shows a schematic illustration of the coil carrier in an installation position.

### DETAILED DESCRIPTION OF THE DRAWINGS

Identical and functionally identical elements are provided with the same reference signs in the figures.

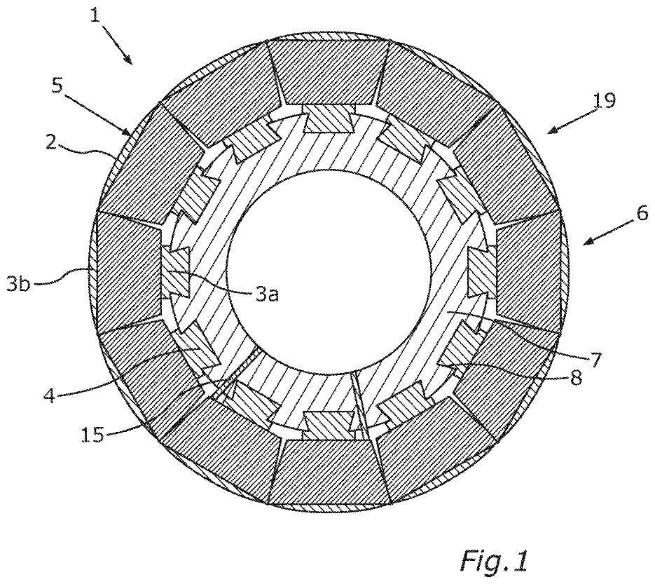

FIG. 1 shows a rotor 1 for a current-excited electric machine which can be used, for example, as a traction machine for an electrified motor vehicle. The rotor 1 has rotor poles 2 with rotor teeth 3a and pole shoes 3b. The rotor teeth 3a and the pole shoes 3b are formed in particular integrally. Tongues 4 are arranged here on the rotor teeth 3a. The rotor poles 2 hold a magnetic-field-generating component 5 for generating a rotor magnetic field. A unit 6 formed from the magnetic-field-generating component 5 and the rotor poles 2 is connected to a rotor yoke 7, which is formed separately from the rotor poles 2, by the tongues 4 engaging in grooves 8 in the rotor yoke 7. In an advantageous arrangement, tongues 4 and grooves 8 are in the form of a dovetail.

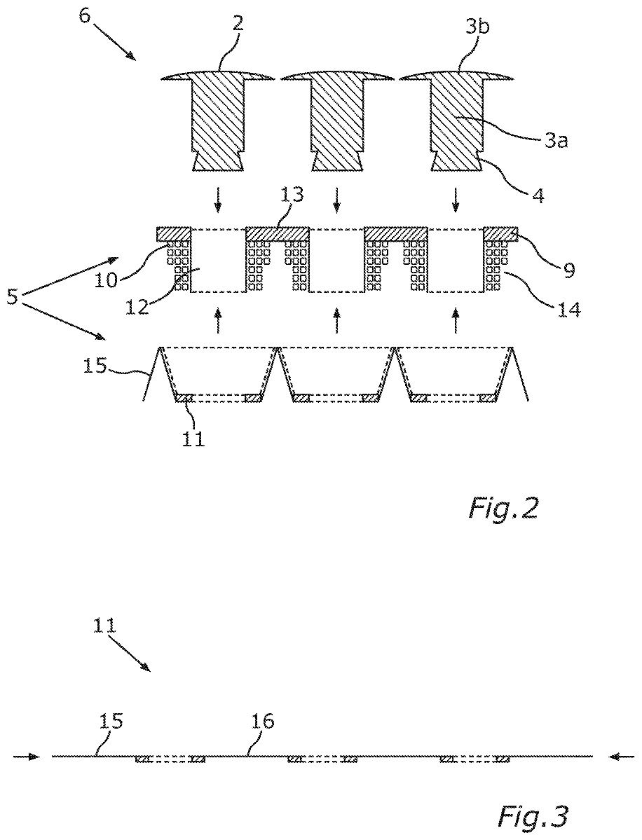

As shown in the illustration of the manufacturing of the unit 6 according to FIG. 2, the magnetic-field-generating component 5 has a coil carrier 9, a winding 10 and an electrically insulating insulation covering 11. The coil carrier 9 has coil bodies 12 assigned to the rotor poles 2, and connecting portions 13 arranged between the coil bodies 12. The connecting portions 13 are configured in such a manner that they ensure a permanent assembly of the coil bodies 12 and the taking on of the function of the groove covering. The connecting portions 13 are also sufficiently flexible in order to permit a change in the relative position of the individual coil bodies 12 with respect to one another to apply the winding 10, introduce the rotor poles 2 and the insulation covering 11 and to complete the rotor 1. For example, the coil carrier 9 is designed as an injection molded part and contains clamping webs to compensate for tolerances in relation to the rotor poles 2.

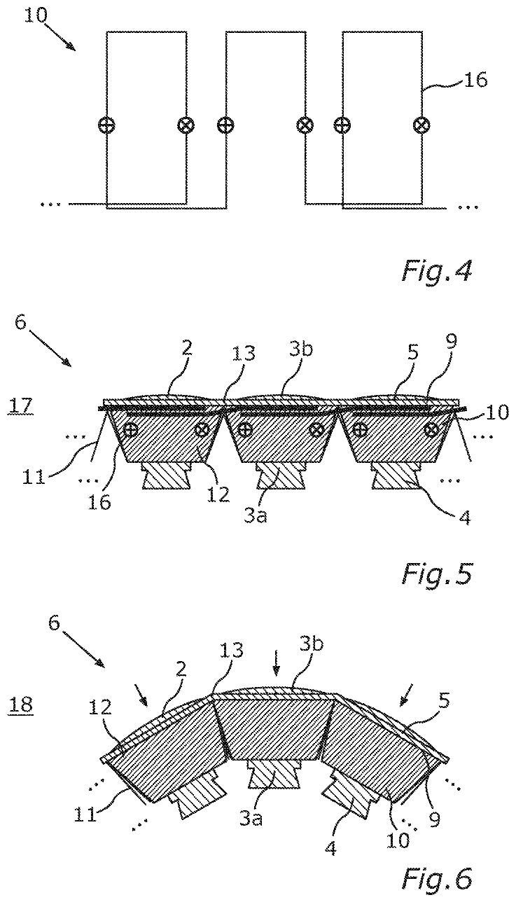

The winding 10 comprises pole coils 14 which are wound from portions of the winding 10 and which are assigned to the individual rotor poles 2, and also external connections 15. In one advantageous embodiment, the winding 10 is formed orthocyclically with a rectangular conductor cross section and integrally, as is shown with reference to the schematic diagram of the winding according to FIG. 4. The insulation covering 11 has the electrical insulation in relation to the rotor yoke 7, pole insulation regions 16 lying between adjacent pole coils 14, and the insulation in relation to external, electrically conducting components. Analogously to the coil carrier 9, the pole insulation regions 16 are sufficiently flexible. Via the flexible connecting portions 13 and the flexible pole insulation regions 16, the coil carrier 9 and the insulation covering 11 can be transferred between a manufacturing position 17 (see FIG. 5) or manufacturing geometry and an installation position 18 (see FIG. 6) or installation geometry. During the transition from the manufacturing geometry 17 into the installation geometry 18, which is predetermined by the construction of the rotor, the flexibility ensures that the geometry of the magnetic-field-generating component 5 can be changed. The manufacturing geometry 17 ensures optimum accessibility of the coil bodies 12, the accessibility comprising an inverted circular shape of the coil carrier 9 with inwardly directed pole shoes for the application of the winding 10. In the manufacturing position 17, the coil carriers 12 are arranged in particular in a row next to one another. The coil carriers 12 are arranged in the installation geometry 18 to form a circle.

In a first embodiment, the insulation covering 11, as shown in FIG. 3, consists of a sheetlike material which is punched in contoured form and unfolded in conjunction with the assembly. In the unfolded state, the unfolded regions overlap to ensure sufficient creep distances. In a second embodiment, not shown here, the insulation covering 11 consists of an electrically insulating material preshaped according to the coil geometry, e.g., an injection molded part. In a particularly advantageous embodiment, the insulation covering 11 assists an impregnation 19 of the magnetic-field-generating component 5 via permeable, e.g., perforated, subregions. The impregnation 19 completes the electrical insulation and strengthens the assembly between the rotor poles 2, the coil carrier 9, the winding 10 and the insulation covering 11.

1.-10. (canceled)

11. A method for producing at least part of a circumference of a rotor for a current-excited electric machine, the method comprising:
providing a rotor yoke;
providing rotor poles which are formed separately from the rotor yoke and are mechanically connectable to the rotor yoke;
providing a coil carrier which has a plurality of coil bodies and flexible connecting portions which are arranged between the coil bodies and via which a relative position of the coil bodies with respect to one another can be changed;
bringing the coil carrier into a manufacturing position via the flexible connecting portions;
equipping the coil carrier with an energizable winding by winding winding portions around the coil bodies;
joining the rotor poles and the coil bodies together such that respective winding portions are wound around the rotor poles to form pole coils;
transferring the coil carrier from the manufacturing position into an installation position via the flexible connecting portions; and
mechanically connecting the rotor poles, which are connected to the coil bodies of the coil carrier, to the rotor yoke.

12. The method according to claim 11, wherein the coil bodies which are connected via the connecting portions form a coil body chain in the manufacturing position and form a coil body ring in the installation position.

13. The method according to claim 11, wherein, for a mechanical connection of the rotor poles to the rotor yoke, the coil carrier which has been brought into the installation position is pushed together axially with the rotor yoke and, in the process, a form-fitting tongue and groove connection is produced between the rotor yoke and the rotor poles.

14. The method according to claim 12, wherein, for a mechanical connection of the rotor poles to the rotor yoke, the coil carrier which has been brought into the installation position is pushed together axially with the rotor yoke and, in the process, a form-fitting tongue and groove connection is produced between the rotor yoke and the rotor poles.

15. The method according to claim 11, wherein a flexible insulation covering is arranged on the coil carrier equipped with the winding, and the insulation covering is transferred together with the coil carrier from the manufacturing position into the installation position.

16. The method according to claim 12, wherein a flexible insulation covering is arranged on the coil carrier equipped with the winding, and the insulation covering is transferred together with the coil carrier from the manufacturing position into the installation position.

17. The method according to claim 13, wherein a flexible insulation covering is arranged on the coil carrier equipped with the winding, and the insulation covering is transferred together with the coil carrier from the manufacturing position into the installation position.

18. The method according to claim 15, wherein the insulation covering is configured with first, flexible pole insulation regions, which are arranged in pole gaps between two pole coils, and is configured with second pole insulation regions, which each have a passage opening for the rotor pole and, when the rotor yoke and coil carrier are joined together, are arranged between the rotor yoke and the pole coils.

19. The method according to claim 16, wherein the insulation covering is configured with first, flexible pole insulation regions, which are arranged in pole gaps between two pole coils, and is configured with second pole insulation regions, which each have a passage opening for the rotor pole and, when the rotor yoke and coil carrier are joined together, are arranged between the rotor yoke and the pole coils.

20. The method according to claim 17, wherein the insulation covering is configured with first, flexible pole insulation regions, which are arranged in pole gaps between two pole coils, and is configured with second pole insulation regions, which each have a passage opening for the rotor pole and, when the rotor yoke and coil carrier are joined together, are arranged between the rotor yoke and the pole coils.

21. The method according to claim 18, wherein the first, flexible pole insulation regions are configured as triangular and/or trapezoidal folds.

22. The method according to claim 19, wherein the first, flexible pole insulation regions are configured as triangular and/or trapezoidal folds.

23. The method according to claim 20, wherein the first, flexible pole insulation regions are configured as triangular and/or trapezoidal folds.

24. The method according to claim 15, wherein the insulation covering is produced by the passage openings being punched out in an electrically insulating material, and the electrically insulating material being unfolded to form the first pole insulation regions.

25. The method according to claim 18, wherein the insulation covering is injection molded to form the first pole insulation regions and the passage openings.

26. The method according to claim 21, wherein the insulation covering is injection molded to form the first pole insulation regions and the passage openings.

27. A current-excited electric machine having a stator and a rotor which is mounted rotatably with respect to the stator and is produced by a method according to claim 11.

28. A motor vehicle having at least one current-excited electric machine according to claim 27.
